(19) United States
(12) Patent Application Publication
(10) Pub. No.: US 2010/0002296 A1
(43) Pub. Date: Jan. 7, 2010

(54) CIRCULAR POLARIZER COMPOSITE AND AN OPTICAL SYSTEM COMPRISING THE SAME

(76) Inventors: Jong-Bok Choi, Kyonggi-do (KR); Seo-Hem Lee, Kyonggi-do (KR); Yeon-Shin Kim, Seoul (KR); Youngsoo Park, Kyonggi-do (KR); Yeong-Yeon Seo, Suwon-si (KR); Youngduck Seo, Seoul (KR)

Correspondence Address: 3M INNOVATIVE PROPERTIES COMPANY, PO BOX 33427, ST. PAUL, MN, 55133-3427, US

(21) Appl. No.: 12/304,334

(22) PCT Filed: May 25, 2007
(86) PCT No.: PCT/US07/69715

§ 371 Date: Jul. 13, 2009

(30) Foreign Application Priority Data
Jun. 13, 2006 (KR) 10-2006-0052905

(51) Int. Cl. G02B 5/30

(52) U.S. Cl. 359/485

(57) ABSTRACT

A circular polarizer composite including a plane polarizer, a first quarter-wavelength retarder, a cholesteric liquid crystal (CLC) film and a second quarter-wavelength retarder, wherein optical axes of the first quarter-wavelength retarder and the second quarter-wavelength retarder are perpendicularly crossed to each other. Also disclosed is an optical system including the circular polarizer composite and an emissive display module.

### BACKGROUND

The present invention is related to a circular polarizer composite comprising a plane polarizer, a first quarter-wavelength retarder, a cholesteric liquid crystal (CLC) film and a second quarter-wavelength retarder, wherein optical axes of the first quarter-wavelength retarder and the second quarter-wavelength retarder are perpendicularly crossed to each other. Further, the present invention provides an optical system comprising said circular polarizer composite and an emissive display module.

Unpolarized ambient light waves vibrate in a large number of directions without a single characterizing electromagnetic radiation vector. By contrast, plane polarized light consists of light waves having a direction of vibration along a single electromagnetic radiation vector. Also, circularly polarized light has a direction of vibration along an electromagnetic radiation vector that rotates as the light propagates through space. Polarized light has many applications in electro-optical devices, such as the use of plane and circular polarizing filters to reduce glare in displays.

Much commercial effort has been directed to the development and improvement of flat panel displays, particularly to flat panel displays that are thinner and more compact than displays requiring backlighting for luminescence. Such flat panel displays may use emissive or electroluminescent displays, i.e., self-luminous displays for which no backlight is required.

FIG. 1 illustrates the schematic structure of an organic light emissive diode (OLED) display using a circular polarizer 10. The OLED display illustrated comprises an OLED 20 as a display module and a circular polarizer 10, wherein the OLED includes an anode 22, an organic layer 24 and a cathode 26 while the circular polarizer 10 includes a quarter-wavelength retarder 14 and a plane polarizer 12. U.S. Pat. No. 6,549,335 (Trapani et al) discloses a circular polarizer including a K-type polarizer and a quarter-wavelength retarder, and an emissive display comprising the same.

In general, plane polarizers have the property of selectively allowing passing of the radiation vibrating along a given electromagnetic radiation vector and absorbing the electromagnetic radiation vibrating along a second electromagnetic radiation vector based on the anisotropic character of the transmitting film medium. Plane polarizers include dichroic polarizers, which absorb plane polarizers utilizing the vectorial anisotropy of the absorption of incident light waves. The term “dichroism” refers to the property of differential absorption of components of incident light, depending on the vibration directions of the component light waves. Light entering a dichroic plane polarizing film encounters two different absorption coefficients along transverse planes, one coefficient being high and the other coefficient being low. Light emerging from a dichroic film vibrates predominantly in the plane characterized by the low absorption coefficient.

A circular polarizer may be constructed of a plane polarizer and a quarter-wavelength retarder. A quarter-wavelength retarder shifts the phase of light waves propagating along one plane through the retarder by one-quarter wavelength, but does not shift the phase of light waves propagating through the retarder along a transverse plane. The result of combining light waves that are one-quarter wavelength out of phase and that vibrate along perpendicular planes is circularly polarized light, for which the electromagnetic radiation vector rotates as the combined light waves travel through space.

Circularly polarized light may be described with respect to two distinct polarization states: left-handed (L) and right-handed (R) circularly polarized light. A circular polarizer absorbs light of one of these polarization states and transmits light of the other polarization state. The use of circular polarizers to reduce glare in displays is wellknown. In particular, light from an emissive display can be selectively transmitted through a circular polarizer, while background ambient light reflected in the display, which causes glare, may be reduced or eliminated.

However, when such a circular polarizer is used in an emissive display, light absorbing by the circular polarizer, in particular by the plane polarizer, leads to reducing the total brightness of the display by half, and thus, it becomes difficult make efficient use of light. In view of internal light (left and right sides) and external light (center) in each component shown in FIG. 1, it can be understood that one electromagnetic radiation vibrating along an electromagnetic radiation vector in the internal light is absorbed by the plane polarizer of the circular polarizer and only the other electromagnetic radiation vibrating along an electromagnetic radiation vector different from the absorbed radiation is transmitted. However, if not using the circular polarizer, due to the reflection by metallic electrodes under ambient light, the contrast ratio would be significantly reduced, and thus, making it difficult for users to see displayed images.

In order to resolve such problems, U.S. Pat. No. 6,841,803 (Aizawa et al) intends to improve light efficiency by using a polarized light separating unit between a circular polarizer and a light emissive component. However, the problem in the aspect of light efficiency cannot be still resolved by reusing a circularly polarized light in other direction, which is not the direction to use, by converting the polarized state simply with reflecting surface. U.S. Pat. No. 5,928,801 (Broer et al) suggests a light emissive device having a reflective polarizer to improve the efficiency of internal light. However, it is still silent on the problems of and solutions to the reduced contrast and glare due to the reflection of ambient light.

### SUMMARY

A circular polarizer, consistent with the present invention, includes a plane polarizer, a first quarter-wavelength retarder, a cholesteric liquid crystal (CLC) film and a second quarter-wavelength retarder. The optical axes of the first quarter-wavelength retarder and the second quarter-wavelength retarder are perpendicularly crossed to each other.

### BRIEF DESCRIPTION OF THE DRAWINGS

FIG. 1 is a schematic drawing showing the structure of an organic light emitting diode (OLED) having a previous circular polarizer, and polarized states of external light and internal light in each component.

FIG. 2 is (a) a schematic drawing showing the structure of an OLED display comprising a circular polarizer and (b) polarized states of external light and internal light in each component.

FIG. 3 illustrates three different pitch layers consisting of layers having red (R), green (G) and blue (B) wavelength ranges, respectively.

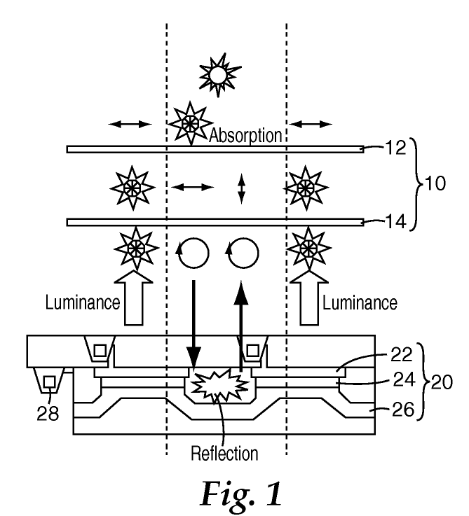

### DETAILED DESCRIPTION OF THE INVENTION

Embodiments of the present invention include a circular polarizer, through using it in an emissive display, to reduce glare caused by reflected light as well as to improve the brightness of internal light emitted from the display, and an optical system comprising the same.

Embodiments of the present invention are related to a circular polarizer composite comprising a plane polarizer, a first quarter-wavelength retarder, a cholesteric liquid crystal (CLC) film and a second quarter-wavelength retarder, in which optical axes of the first quarter-wavelength retarder and the second quarter-wavelength retarder are perpendicularly crossed to each other. The CLC film in the composite may comprise three different pitch layers, in which the three different pitch layers may comprise of layers having red (R), green (G) and blue (B) wavelength ranges, respectively.

Further, embodiments of the present invention are related to an optical system comprising a circular polarizer composite comprising a plane polarizer, a first quarter-wavelength retarder, a cholesteric liquid crystal (CLC) film and a second quarter-wavelength retarder, and an emissive display module, wherein optical axes of the first quarter-wavelength retarder and the second quarter-wavelength retarder are perpendicularly crossed to each other. The CLC film in the composite may comprise three different pitch layers, wherein the three different pitch layers may be consisting of layers having red (R), green (G) and blue (B) wavelength ranges, respectively. In addition, the emissive display module may be an organic light emitting diode or a plasma display device.

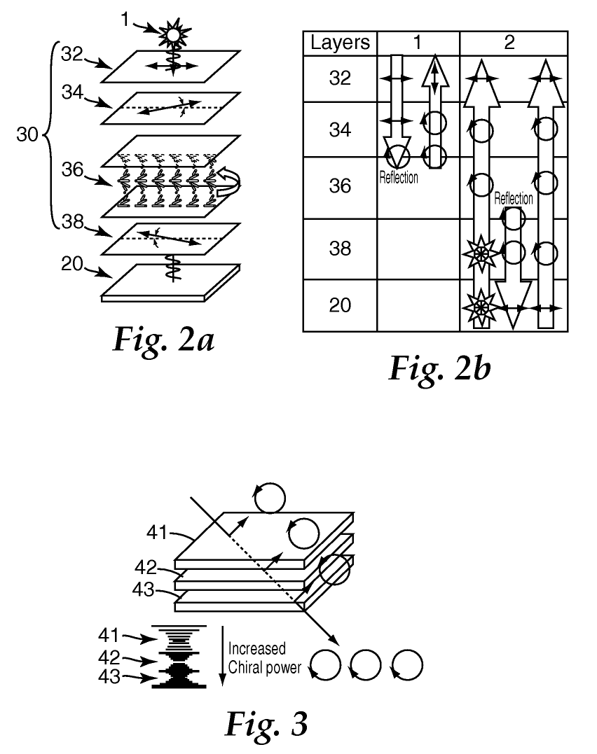

FIG. 2 is (a) a schematic drawing showing the structure of an OLED display comprising a circular polarizer composite 30, and (b) polarized states of external light 1 and internal light 2 in each component. The circular polarizer composite 30 comprises a plane polarizer 32, a first quarter-wavelength retarder 34, a cholesteric liquid crystal (CLC) film 36 and a second quarter-wavelength retarder 38, wherein optical axes of the first quarter-wavelength retarder 34 and the second quarter-wavelength retarder 38 are perpendicularly crossed to each other.

The cholesteric liquid crystal film 36 can substantially reflect light having one circular polarization (e.g., left or right circularly polarized light) and substantially transmit light having the other circular polarization (e.g., right or left circularly polarized light) over a particular bandwidth of light wavelengths.

Using the circular polarizer 30, in case of external light 1, due to the plane polarizer 32, electromagnetic radiation vibrating along a first electromagnetic radiation vector is transmitted and electromagnetic radiation vibrating along a second electromagnetic radiation vector is absorbed, as shown in FIG. 2. The transmitted electromagnetic radiation, due to the first quarter-wavelength retarder 34, becomes to have a first circularly polarized light, which is substantially reflected by the CLC film 36. It becomes to have a plane polarized light by passing through the first quarter-wavelength retarder 34 twice, the polarized direction being converted into the second electromagnetic radiation vector, and is absorbed by the plane polarizer 32 without being leaked out.

In case of internal light 2, light having a second circularly polarized light, which is substantially transmitted by the CLC film 36, transmits the CLC film, and then, becomes to have a plane polarized light with passing through the first quarter-wavelength retarder 34, the polarized direction being converted into the first electromagnetic radiation vector. It is then transmitted to the outside. On the other hand, in case of the light having the second circularly polarized light substantially reflected by the CLC film 36, the polarized direction is converted into the first circularly polarization by passing through the second quarter-wavelength retarder 38. After that, when it contacts with the CLC film 36, it substantially transmits the CLC film. After transmitting the CLC film 36, it is converted into the first electromagnetic radiation capable of transmitting the plane polarizer 32 by passing through the first quarter-wavelength retarder 34, and then, finally transmits to the outside. Therefore, when using the circular polarizer composite 30, internal light 2 emitted from the emissive display module 20 can be efficiently used, while reducing the contrast ratio by the reflection of external light 1 in the metallic electrodes.

Hereinafter, each component for use in the circular polarizer and the optical system is specified.

Cholesteric Liquid Crystal (CLC) Films

Cholesteric liquid crystal compounds are typically chiral molecules and can be polymers. Such compounds typically include molecular units that are chiral in nature (e.g., do not posses a mirror plane) and molecular units that are mesogenic in nature (e.g., exhibit liquid crystal phases). Cholesteric liquid crystal compounds include compounds having a cholesteric liquid crystal phase in which the director (i.e., the unit vector in the direction of average local molecular alignment) of the liquid crystal rotates in a helical fashion along the dimension perpendicular to the director. Cholesteric liquid crystal compounds are also referred to as chiral nematic liquid crystal compounds. The pitch of the cholesteric liquid crystal compound is the distance (in a direction perpendicular to the director) that it takes for the director to rotate through 360°. This distance is typically 100 nm or more.

The pitch of a cholesteric liquid crystal compound can typically be altered by mixing or otherwise combining (e.g., by copolymerization) a chiral compound (e.g., a cholesteric liquid crystal compound) with a nematic liquid crystal compound. The pitch is generally selected to be on the order of the wavelength of light of interest. The helical twist of the director results in a spatially periodic variation in the dielectric tensor, which in turn gives rise to the wavelength selective reflection of light. For example, the pitch can be selected such that the selective reflection is peaked in the visible, ultraviolet, or infrared wavelengths of light.

Cholesteric liquid crystal compounds, including cholesteric liquid crystal polymers, are generally known and typically any of these materials can be used to make optical bodies. Examples of suitable cholesteric liquid crystal polymers are described in U.S. Pat. No. 4,293,435 (Portugall et al) and U.S. Pat. No. 5,332,522 (Chen et al). However, other cholesteric liquid crystal compounds can also be used. Typically, a cholesteric liquid crystal compound is selected for a particular application or optical body based on one or more factors including, for example, refractive indices, pitch, processability, clarity, color, low absorption in the wavelength of interest, compatibility with other components (e.g., a nematic liquid crystal compound), ease of manufacture, availability of the liquid crystal compound or monomers to form a liquid crystal polymer, rheology, method and requirements of curing, ease of solvent removal, physical and chemical properties (for example, flexibility, tensile strength, solvent resistance, scratch resistance, and phase transition temperature), and ease of purification.

Cholesteric liquid crystal polymers are typically formed using chiral (or a mixture of chiral and achiral) molecules (including monomers) that can include a mesogenic group (e.g., a rigid group that typically has a rod-like structure to facilitate formation of a cholesteric liquid crystal phase). Mesogenic groups include, for example, para-substituted cyclic groups (e.g., para-substituted benzene rings). These mesogenic groups are optionally bonded to a polymer backbone through a spacer. The spacer can contain functional groups having, for example, benzene, pyridine, pyrimidine, alkyne, ester, alkylene, alkane, ether, thioether, thioester, and amide functionalities.

Suitable cholesteric liquid crystal polymers include polymers having a chiral polyester, polycarbonate, polyamide, polymethacrylate, polyacrylate, polysiloxane, or polyesterimide backbone that includes mesogenic groups optionally separated by rigid or flexible comonomers. Other suitable cholesteric liquid crystal polymers have a polymer backbone (for example, a polyacrylate, polymethacrylate, polysiloxane, polyolefin, or polymalonate backbone) with chiral mesogenic side-chain groups. The side-chain groups are optionally separated from the backbone by a spacer, such as an alkylene or alkylene oxide spacer, to provide flexibility.

Typically, to form a cholesteric liquid crystal layer, a cholesteric liquid crystal composition is coated onto a surface. The cholesteric liquid crystal composition includes at least one chiral compound (e.g., cholesteric liquid crystal compound) or chiral monomer (cholesteric liquid crystal monomer) that can be used (e.g., polymerized or crosslinked) to form a cholesteric liquid crystal polymer. The cholesteric liquid crystal composition can also include at least one nematic liquid crystal compound or nematic liquid crystal monomer that can be used to form a nematic liquid crystal polymer. The nematic liquid crystal compound(s) or nematic liquid crystal monomer(s) can be used to modify the pitch of the cholesteric liquid crystal composition. The cholesteric liquid crystal composition can also include one or more processing additives, such as, for example, curing agents, crosslinkers, or ultraviolet, infrared, antiozonant, antioxidant, or visible light-absorbing dyes.

Cholesteric liquid crystal compositions can also be formed using two or more different types of any of the following: cholesteric liquid crystals, cholesteric liquid crystal monomers, nematic liquid crystals, nematic liquid crystal monomers, or combinations thereof. The particular ratio(s) by weight of materials in the cholesteric liquid crystal composition will typically determine, at least in part, the pitch of the cholesteric liquid crystal layer.

The cholesteric liquid crystal composition also typically includes a solvent. The term “solvent,” as used herein, also refers to dispersants and combinations of two or more solvents and dispersants. In some instances, one or more of the liquid crystal compounds, liquid crystal monomers, or processing additives also acts as a solvent. The solvent can be substantially eliminated from the coating composition by, for example, drying the composition to evaporate the solvent or reacting a portion of the solvent (e.g., reacting a solvating liquid crystal monomer to form a liquid crystal polymer).

After coating, the cholesteric liquid crystal composition is converted into a liquid crystal layer. This conversion can be accomplished by a variety of techniques including evaporation of a solvent; crosslinking the cholesteric liquid crystal compound(s) or cholesteric liquid crystal monomer(s); or curing (e.g., polymerizing) the cholesteric liquid crystal monomer(s) using, for example, heat, radiation (e.g., actinic radiation), light (e.g., ultraviolet, visible, or infrared light), an electron beam, or a combination of these or like techniques.

The cholesteric liquid crystal phase can be achieved using conventional treatments. For example, a method of developing a cholesteric liquid crystal phase includes depositing the cholesteric liquid crystal composition on an oriented substrate. The substrate can be oriented using, for example, drawing techniques or rubbing with a rayon or other cloth. After deposition, the cholesteric liquid crystal composition is heated above the glass transition temperature of the composition to the liquid crystal phase. The composition is then cooled below the glass transition temperature; the liquid crystal phase remaining fixed.

Cholesteric liquid crystal compositions (with or without additional nematic liquid crystal compound(s) or monomer(s) added to modify the pitch) can be formed into a film that substantially reflects light having one circular polarization (e.g., left or right circularly polarized light) and substantially transmits light having the other circular polarization (e.g., right or left circularly polarized light) over a particular bandwidth of light wavelengths. This characterization describes the reflection or transmission of light directed at normal incidence to the director of the cholesteric liquid crystal material. Light that is directed at other angles will typically be elliptically polarized by the cholesteric liquid crystal material. Cholesteric liquid crystal materials are generally characterized with respect to normally incident light, as done below, however, it will be recognized that the response of these materials can be determined for non-normally incident light using known techniques.

The cholesteric liquid crystal film can be used alone or in combination with other layers or devices to form an optical body, such as, for example, a reflective polarizer. Cholesteric liquid crystal polarizers are used in one type of reflective polarizer. The pitch of a cholesteric liquid polarizer is similar to the optical layer thickness of multilayer reflective polarizers. Pitch and optical layer thickness determine the center wavelength of the cholesteric liquid crystal polarizers and multilayer reflective polarizers, respectively. The rotating director of the cholesteric liquid crystal polarizer forms optical repeat units similar to the use of multiple layers having the same optical layer thickness in multilayer reflective polarizers.

The center wavelength, λ₀, and the spectral bandwidth, Δλ, of the light reflected by the cholesteric liquid crystal layer depend on the pitch, p, of the cholesteric liquid crystal. The center wavelength, λ₀, is approximated by:

λ₀=0.5(n₀+nₑ)p

where n₀ and nₑ are the refractive indices of the cholesteric liquid crystal for light polarized parallel to the director of the liquid crystal (nₑ) and for light polarized perpendicular to the director of the liquid crystal (n₀). The spectral bandwidth, Δλ, is approximated by:

Δλ=2λ₀(nₑ−n₀)/(nₑ+n₀)=p(nₑ−n₀).

The spectral width (measured as full width at half peak height) of a cholesteric liquid crystal composition is typically about 100 nm or less. This limits the usefulness of a cholesteric liquid crystal polymer when reflectivity over the entire visible light range (about 400 to 750 nm) or other wavelength range substantially larger than 100 nm is desired. Birefringence of the material corresponds to nₑ−n₀.

To make a reflective polarizer capable of reflecting a broad range of wavelengths, multiple cholesteric liquid crystals can be used. When making polarizers with multiple layers of cholesteric liquid crystals, each layer has a different pitch and, therefore, reflects light having a different wavelength. With a sufficient number of layers, a polarizer can be constructed that reflects a large portion of the visible light spectrum. The pitch is generally selected to be on the order of wavelength of light of interest. For example, the pitch can be selected to be on the order of visible, ultraviolet, or infrared wavelengths of light, or selected to be on the order of red (R), green (G), or blue (B) wavelengths of the visible light. FIG. 3 illustrates three different pitch layers consisting of layers having red (R) 41, green (G) 42 and blue (B) 43 wavelength ranges, respectively.

Plane Polarizers

In general, plane polarizers have the property of selectively passing radiation vibrating along a given electromagnetic radiation vector and absorbing electromagnetic radiation vibrating along a second electromagnetic radiation vector based on the anisotropic character of the transmitting film medium. Plane polarizers include dichroic polarizers, which are absorbing plane polarizers utilizing the vectorial anisotropy of their absorption of incident light waves. Light entering a dichroic plane polarizer encounters two different absorption coefficients along transverse planes, one coefficient being high and the other coefficient being low. Light emerging from a dichroic polarizer vibrates predominantly in the plane characterized by the low absorption coefficient.

Dichroic plane polarizers include iodine, dyestuff and H-type polarizers. An H-type polarizer is a synthetic dichroic sheet polarizer including a polyvinyl alcoholiodine complex. Such a chemical complex is referred to as a chromophore.

In contrast to H-type polarizers, other synthetic dichroic plane polarizers are K-type polarizers. A K-type polarizer is a synthetic dichroic plane polarizer based on molecularly oriented polyvinyl alcohol (PVA) sheets or films with a balanced concentration of light-absorbing chromophores. A K-type polarizer derives its dichroism from the light absorbing properties of its matrix, not from the light-absorbing properties of dye additives, stains, or suspended crystalline materials.

Quarter-Wavelength Retarders

Quarter-wavelength retarders convert the transmitted circularly polarized light into linearly polarized light. Circular polarizers do not function in the same Cartesian coordinate eigen space as linear polarizers, and it is the optical axis of the quarter-wavelength retarder that specifies the azimuthal orientation of the plane of polarization of the linearly polarized light. Quarter-wavelength retarders are often made by orienting birefringent films. On passing through a quarter-wavelength retarder, circularly polarized light is converted to linearly polarized light with its polarization axis +45 or −45 degrees away from the optical axis of the quarter-wavelength retarder, with the direction determined by the specific circular polarization state. Quarter-wavelength retarders are often made by orienting films with the optical axis either parallel or perpendicular to the film roll direction. Thus, the output light of such a structure will be at 45 or 135 degrees to the web direction.

Emissive Displays

As a typical emissive display module, there is an organic light emitting diode (OLED). A typical OLED display includes a metallic cathode, organic layers, a transparent anode and a display surface. Cathode may be made, e.g., of aluminum. Anode may be made, e.g., of indium tin oxide. Display surface may be made, e.g., of glass. Organic layers, which are disposed between cathode and anode include a hole-injection layer, a hole-transport layer, an emissive layer, and an electron-transport layer. When a voltage, e.g., on the order of a few volts, is applied across the anode and cathode, injected positive and negative charges in the hole-transport layer and the electron-transport layer recombine in the emissive layer to produce light, i.e., electroluminescence. The construction of OLEDs is well known in the field of flat panel displays.

A plasma display panel is another type of emissive display module. In a typical gas plasma display panel, each individual pixel or picture element of the display includes three small bulbs that produce light of different colors. The bulbs produce light by running a high-voltage electric current through a gas to convert the gas into the plasma state of matter, which emits light.

While the invention has been described with respect to illustrative examples above, various modifications may be made without departing from the spirit and scope of the present invention as defined by the appended claims and their equivalents.

With using the circular polarizer, reducing glare caused by reflected light as well as improving the brightness of internal light emitted from the display can be achieved.

What is claimed:

1. A circular polarizer composite, comprising:
a plane polarizer;
a first quarter-wavelength retarder;
a cholesteric liquid crystal (CLC) film; and
a second quarter-wavelength retarder,
wherein optical axes of the first quarter-wavelength retarder and the second quarter-wavelength retarder are perpendicularly crossed to each other.

2. The circular polarizer composite of claim 1, wherein the CLC film comprises three different pitch layers.

3. The circular polarizer composite of claim 2, wherein the three different pitch layers comprise layers having red (R), green (G) and blue (B) wavelength ranges, respectively.

4. An optical system, comprising:
a circular polarizer composite, comprising:
a plane polarizer;
a first quarter-wavelength retarder;
a cholesteric liquid crystal (CLC) film;
a second quarter-wavelength retarder; and
an emissive display module,
wherein optical axes of the first quarter-wavelength retarder and the second quarter-wavelength retarder are perpendicularly crossed to each other.

5. The optical system of claim 4, wherein the CLC film comprises three different pitch layers.

6. The optical system of claim 5, wherein the three different pitch layers comprise layers having red (R), green (G) and blue (B) wavelength ranges, respectively.

7. The optical system of claim 4, wherein the emissive display module is an organic light emitting diode or a plasma display device.
